(19) United States
(12) Patent Application Publication
(10) Pub. No.: US 2021/0034672 A1
(43) Pub. Date: Feb. 4, 2021

(54) METADATA GENERATION APPARATUS, METADATA GENERATION METHOD, AND PROGRAM

(71) Applicant: OMRON Corporation, Kyoto-shi, KYOTO (JP)

(72) Inventors: Hiroshi IMAI, Kyoto-shi (JP); Tetsuji YAMATO, Kyoto-shi (JP); Taiji YOSHIKAWA, Kyoto-shi (JP)

(73) Assignee: OMRON Corporation, Kyoto-shi, KYOTO (JP)

(21) Appl. No.: 16/964,270

(22) PCT Filed: Nov. 29, 2018
(86) PCT No.: PCT/JP2018/043936

§ 371 Date: Jul. 23, 2020

(30) Foreign Application Priority Data
Feb. 27, 2018 (JP) 2018-033040

(51) Int. Cl. G06F 16/908; G06N 20/00; G06N 7/00

(52) U.S. Cl. CPC G06F 16/908; G06N 7/005; G06N 20/00

(57) ABSTRACT

Provided is a metadata generation apparatus. The metadata generation apparatus generates metadata that is associated with a processing module. The processing module is a trained model generated by using a plurality of sets of learning data. Each set of the learning data includes input data and a correct label of output data. The metadata generation apparatus includes a probability density function generation unit and a metadata generation unit. The probability density function generation unit generate a probability density function of a plurality of sets of input data associated with the same correct label. The metadata generation unit generates metadata based on the probability density function.

### TECHNICAL FIELD

The present invention relates to a metadata generation apparatus, a metadata generation method, and a program.

### RELATED ART

JP-A-2014-45242 (Patent Document 1) discloses a virtual sensor generation apparatus that generates a virtual sensor. This virtual sensor generation apparatus detects an actual sensor that is present within a predetermined range, and generates a virtual sensor by using the detected actual sensor (see Patent Document 1).

### RELATED ART DOCUMENTS

### Patent Document

Patent Document 1: JP 2014-45242A

### SUMMARY OF THE INVENTION

### Problem to be Solved by the Invention

A virtual sensor such as that disclosed in Patent Document 1 mentioned above includes, for example, an actual sensor (an example of a device) and a processing module. The processing module is a trained model generated by using a plurality of sets of learning data, for example, and processes sensing data (an example of input data) output by the actual sensor so as to generate output data different from the input data.

In such a case, a situation may occur in which, if data output by a device whose attributes are totally different from the attributes of a device used for generating the learning data is input to the processing module, a principal function of the trained model is not exerted, and, as a result, the virtual sensor cannot exert its desired function.

The present invention has been made in order to solve such a problem, and aims to provide a metadata generation apparatus capable of generating metadata that is associated with a processing module, and is useful for avoiding input of inappropriate data to the processing module, as well as a metadata generation method and program.

### Means for Solving the Problems

A metadata generation apparatus according to an aspect of the present invention is configured to generate metadata that is associated with a processing module. The processing module is a trained model generated by using a plurality of sets of learning data, and is configured to generate, based on at least one set of input data, output data that is different from the input data. Each of the plurality of sets of learning data includes input data and a correct label of the output data associated with the input data. The metadata generation apparatus includes a probability density function generation unit and a metadata generation unit. The probability density function generation unit is configured to generate a probability density function of a plurality of sets of input data associated with the same correct label. The metadata generation unit is configured to generate metadata based on the probability density function.

As described above, the processing module is a trained model generated by using a plurality of sets of learning data. The trained model is based on the attributes of a device that has output the learning data, and thus, when data output by a device whose attributes are totally different is input, the trained model does not necessarily output a desired result. This metadata generation apparatus generates metadata based on a probability density function of a plurality of sets of input data (included in the learning data) associated with a common correct label (included in the learning data). The metadata reflects the attributes of the device that has output the learning data. By referring to that metadata, a device whose attributes are similar to the attributes of the device that has output the learning data can be selected as a device that outputs input data to the processing module, for example, and it is possible to avoid input of inappropriate data to the processing module. Therefore, with this metadata generation apparatus, it is possible to generate metadata that is useful for avoiding input of inappropriate data to the processing module.

In addition, in the above-described metadata generation apparatus, the probability density function generation unit may be configured to generate a probability density function for each correct label included in the plurality of sets of learning data.

In this metadata generation apparatus, a probability density function of input data is generated for each correct label, and metadata is generated based on a plurality of generated probability density functions. Therefore, with this metadata generation apparatus, it is possible to generate metadata that reflects, in more detail, the attributes of the device that has output the learning data.

In addition, the input data may be sensing data that is output by a sensing device.

In addition, the processing module may be configured to generate the output data based on the plurality of sets of input data.

In addition, a virtual sensor may be formed of the processing module and a device that outputs the input data to the processing module.

In a metadata generation method according to another aspect of the present invention, metadata that is associated with a processing module is generated. The processing module is a trained model generated by using a plurality of sets of learning data, and is configured to generate, based on at least one set of input data, output data that is different from the input data. Each of the plurality of sets of learning data includes input data and a correct label of output data associated with the input data. The metadata generation method includes a step of generating a probability density function of a plurality of sets of input data associated with the same correct label, and a step of generating metadata based on the probability density function.

According to this metadata generation method, metadata is generated based on a probability density function of a plurality of sets of input data (included in the learning data) associated with a common correct label (included in the learning data). The metadata reflects the attributes of the device that has output the learning data. By referring to that metadata, a device whose attributes are similar to the attributes of the device that has output the learning data can be selected as a device that outputs input data to the processing module, for example, and it is possible to avoid input of inappropriate data to the processing module. Therefore, with this metadata generation apparatus, it is possible to generate metadata that is useful for avoiding input of inappropriate data to the processing module.

A program according to another aspect of the present invention causes a computer to execute processing for generating metadata that is associated with a processing module. The processing module is a trained model generated by using a plurality of sets of learning data, and is configured to generate, based on at least one set of input data, output data that is different from the input data. Each of the plurality of sets of learning data includes input data and a correct label of output data associated with the input data. The program is configured to cause the computer to execute a step of generating a probability density function of a plurality of sets of input data associated with each specific correct label, and a step of generating metadata based on the probability density function.

When this program is executed by a computer, metadata is generated based on a probability density function of a plurality of sets of input data (included in the learning data) associated with a common correct label (included in the learning data). The metadata reflects the attributes of a device that has output the learning data. By referring to that metadata, a device whose attributes are similar to the attributes of the device that has output the learning data can be selected as a device that outputs input data to the processing module, for example, and it is possible to avoid input of inappropriate data to the processing module. Therefore, with this program, it is possible to generate metadata that is useful for avoiding input of inappropriate data to the processing module.

### Effects of the Invention

According to the present invention, it is possible to provide a metadata generation apparatus capable of generating metadata that is associated with a processing module, and is useful for avoiding input of inappropriate data to the processing module, as well as a metadata generation method and program.

### BRIEF DESCRIPTION OF THE DRAWINGS

FIG. 1 is a diagram for illustrating an overview of a metadata generation apparatus.

FIG. 2 is a diagram showing an example of a sensor network system according to a first embodiment.

FIG. 3 is a diagram showing an example of the hardware configuration of a virtual sensor management server according to the first embodiment.

FIG. 4 is a diagram showing an example of a learning data DB.

FIG. 5 is a diagram showing an example of a first metadata DB.

FIG. 6 is a diagram showing an example of a portion of the software configuration of a virtual sensor management server (including a first metadata generation module).

FIG. 7 is a diagram showing an example of a portion of the software configuration of the virtual sensor management server according to the first embodiment (including a compatibility determination module).

FIG. 8 is a flowchart showing an example of an operation of generating first metadata.

FIG. 9 is a flowchart showing an example of an operation of determining the compatibility of a sensing device according to the first embodiment.

FIG. 10 is a diagram showing a sensor network system according to a second embodiment.

FIG. 11 is a diagram showing the hardware configuration of a virtual sensor management server according to the second embodiment.

FIG. 12 is a diagram showing an example of a second metadata DB.

FIG. 13 is a diagram showing an example of a portion of the software configuration of the virtual sensor management server according to the second embodiment (including a compatibility determination module).

FIG. 14 is a flowchart showing an example of an operation of determining the compatibility of a sensing device according to the second embodiment.

### EMBODIMENTS OF THE INVENTION

Embodiments according to aspects of the present invention (hereinafter, also referred to as “the embodiment”) will be described below in detail with reference to drawings. Note that, in the drawings, the same reference numerals are given to the same or equivalent constituent elements, and a description thereof is not repeated. In addition, the embodiments to be described below are only examples of the present invention in all respects. Various modifications and changes can be made to the embodiments within the scope of the present invention. Accordingly, when implementing the present invention, a specific configuration can be adopted as appropriate according to an embodiment.

### 1. FIRST EMBODIMENT

### 1-1. Overview

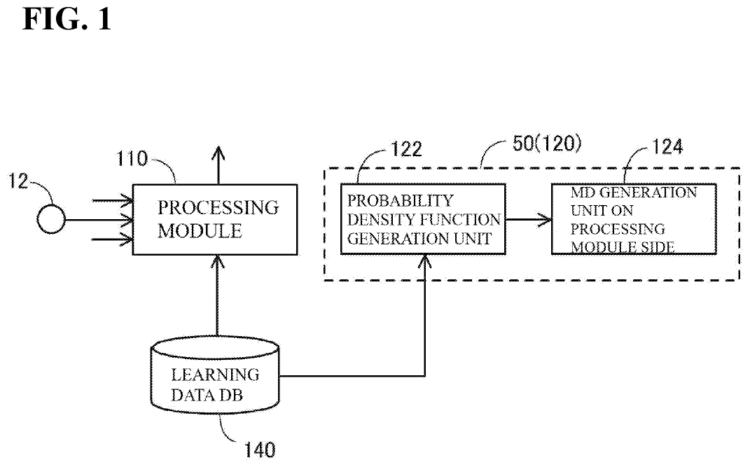

FIG. 1 is a diagram for illustrating an overview of a metadata generation apparatus 50 (a metadata generation module 120 on a processing module side (to be described later)) according to a first embodiment. As shown in FIG. 1, a processing module 110 includes one or more input ports, and sensing data (an example of input data) output by a sensing device 12 (an example of a device) is input to each of the input ports. The processing module 110 is configured to generate, based on input data, output data that is different from the input data. Accordingly, a so-called virtual sensor is formed of the processing module 110 and the sensing device 12 (input sensor) that outputs input data to the processing module 110. The virtual sensor is a sensor module that outputs, based on sensing data generated by the input sensor observing a target, a result of observing a target that is different from the target observed by the input sensor, as sensing data. The virtual sensor will be described later in detail.

The processing module 110 is a trained model generated by using a plurality of sets of learning data. The plurality of sets of learning data are read out from a learning data DB (database) 140 when generating the processing module 110, for example. Each set of the learning data includes input data that is input to the processing module 110 (sensing data output by the sensing device 12) and a correct label of output data of the processing module 110 when that input data is input.

When data output by a sensing device 12 whose attributes are totally different from the attributes of the sensing device 12 used for generating the learning data is input to the processing module 110, a situation may occur in which a principal function of the trained model is not exerted, and, as a result, the virtual sensor cannot exert its desired function.

In order to avoid such a situation, the metadata generation apparatus 50 according to the first embodiment generates metadata that is associated with the processing module 110, and that is useful for avoiding input of inappropriate data to the processing module 110.

Specifically, the metadata generation apparatus 50 includes a probability density function generation unit 122 and a metadata generation unit on the processing module side (hereinafter, also referred to as a “first metadata generation unit”) 124. The probability density function generation unit 122 reads out learning data used when generating the processing module 110, from the learning data DB 140, and generates a probability density function of a plurality of sets of input data associated with the same correct label. The first metadata generation unit 124 generates metadata (hereinafter, also referred to as “first metadata”) based on generated probability density functions.

The probability density functions generated by the probability density function generation unit 122 reflect the attributes of the sensing device 12 used for generating the learning data. Therefore, the first metadata generated based on the probability density functions also reflect the attributes of the sensing device 12 used for generating the learning data. By referring to the first metadata, a sensing device 12 whose attributes are similar to the attributes of the sensing device 12 that output the learning data can be selected as a sensing device 12 that outputs input data to the processing module 110, for example. As a result, it is possible to avoid a situation where inappropriate data is input to the processing module 110. Therefore, with the metadata generation apparatus 50, it is possible to generate metadata (first metadata) that is useful for avoiding input of inappropriate data to the processing module 110.

### 1-2. Configuration

### 1-2-1. Overall System Configuration

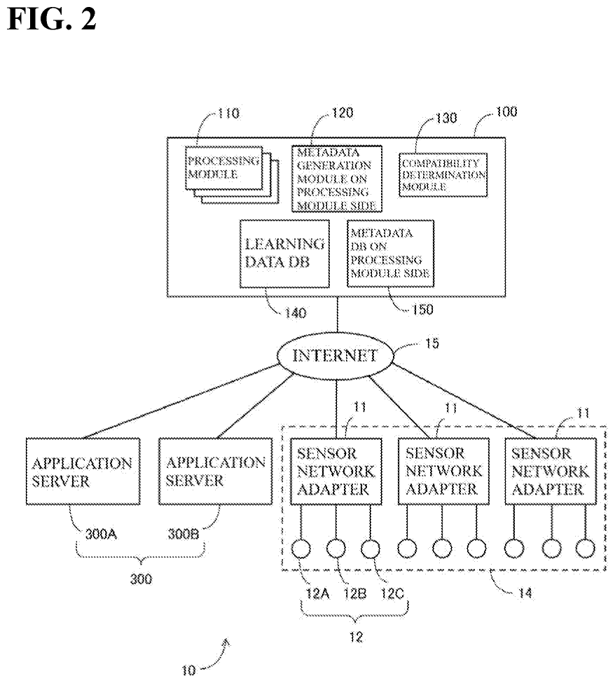

FIG. 2 is a diagram showing an example of a sensor network system 10 that includes the metadata generation module on the processing module side (hereinafter, also referred to as a “first metadata generation module”) 120 according to the first embodiment. In the example in FIG. 2, the sensor network system 10 includes a sensor network unit 14, a virtual sensor management server 100, and application servers 300.

The sensor network unit 14, the virtual sensor management server 100, and the application servers 300 are connected via the Internet 15 so that they can communicate with each other. Note that the numbers of constituent elements included in the sensor network system 10 (the number of virtual sensor management servers 100, the number of application servers 300, the number of sensor network adapters 11, the number of sensing devices 12, and the like) are not limited to those shown in FIG. 2.

Sensing data generated by the sensing devices 12 can be distributed in the sensor network system 10. For example, sensing data generated by the sensing devices 12 can be distributed to the virtual sensor management server 100, and sensing data generated by a virtual sensor can be distributed to the application servers 300.

The sensor network unit 14 includes a plurality of the sensor network adapters 11, for example. A plurality of sensing devices 12 are connected to each of the plurality of sensor network adapters 11, and the sensing devices 12 are connected to the Internet 15 via the sensor network adapters 11.

The sensing devices 12 are configured to obtain sensing data by observing a target. The sensing devices 12 may be image sensors (cameras), temperature sensors, humidity sensors, illuminance sensors, force sensors, audio sensors, speed sensors, acceleration sensors, RFID (radio frequency identification) sensors, infrared sensors, posture sensors, rainfall sensors, radiation sensors, and/or gas sensors, for example. Also, the sensing devices 12 do not necessarily need to be fixed, and may also be mobile devices such as a mobile phone, a smartphone and a tablet. Each of the sensing devices 12 does not necessarily need to be constituted by a single sensor, and may also be constituted by a plurality of sensors. Moreover, the sensing devices 12 may be installed for any purpose, and may be installed for FA (factory automation) and production management in a factory, urban traffic control, environment measurements such as weather measurements, healthcare, crime-prevention, or the like.

In the sensor network unit 14, the sensor network adapters 11 are arranged at separate (far) locations, and sensing devices 12 connected to each of the sensor network adapters 11 are arranged at the same (close) locations, for example, but the arrangement locations of these are not limited thereto.

The application servers 300 (300A, 300B) are each configured to execute an application that uses sensing data, and is realized by a general-purpose computer, for example. The application servers 300 obtain necessary sensing data via the Internet 15.

The virtual sensor management server 100 is a server for realizing a virtual sensor. In the virtual sensor management server 100, a plurality of processing modules 110, the first metadata generation module 120, and a compatibility determination module 130 are realized, and the learning data DB 140 and a first metadata DB 150 are managed. The plurality of processing modules 110, the first metadata generation module 120, and the compatibility determination module 130 are software modules, for example.

Each of the processing modules 110 includes at least one input port, and is configured to generate, based on input data input to the input port, output data that is different from the input data. The processing module 110 can switch a sensing device 12 that outputs input data to the input port as necessary. If, for example, the sensing device 12 that is currently outputting input data to the input port is broken, the processing module 110 can switch the input sensor to another sensing device 12.

A processing module 110 may also be configured to output data indicating the number of persons that are present in a room, based on input data (sound data) that is output by an audio sensor disposed in the room, for example. In this case, a virtual sensor that detects the number of persons in the room can be realized by the processing module 110 and the sensing device 12 (audio sensor).

The first metadata generation module 120 is configured to generate first metadata that is associated with the processing modules 110. The compatibility determination module 130 is configured to determine the compatibility of the sensing device 12 that outputs input data to the processing module 110. The software modules and databases will be described later in detail.

### 1-2-2. Hardware Configuration of Virtual Sensor Management Server

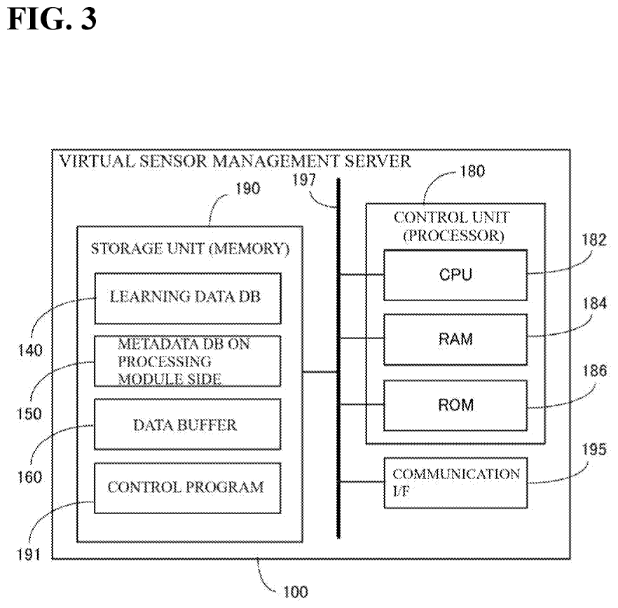

FIG. 3 is a diagram showing an example of the hardware configuration of the virtual sensor management server 100. Note that, according to the first embodiment, the virtual sensor management server 100 is realized by a general-purpose computer, for example.

In the example in FIG. 3, the virtual sensor management server 100 includes a control unit 180, a communication I/F (interface) 195, and a storage unit 190, and the constituent elements are electrically connected via a bus 197.

The control unit 180 includes a CPU (central processing unit) 182, a RAM (random access memory) 184, a ROM (read only memory) 186, and the like, and is configured to control the constituent elements in accordance with information processing.

The communication I/F 195 is configured to communicate with an external apparatus (for example, an application server 300 or the sensor network unit 14 (FIG. 2)) provided outside of the virtual sensor management server 100, via the Internet 15. The communication I/F 195 is constituted by a wired LAN (local area network) module or a wireless LAN module, for example.

The storage unit 190 is a secondary storage device such as a hard disk drive or a solid state drive. The storage unit 190 is configured to store the learning data DB 140, the first metadata DB 150, and a control program 191, for example.

In addition, a data buffer 160 is provided in a portion of the storage region of the storage unit 190.

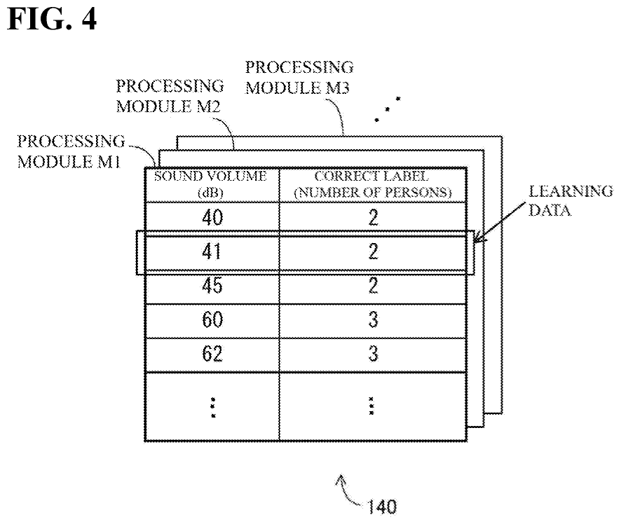

FIG. 4 is a diagram showing an example of the learning data DB 140. In the example in FIG. 4, learning data used when a processing module 110 was generated is managed in the learning data DB 140. In this example, a processing module M1 is configured to output data on the number of persons that are present in a room in which an audio sensor is disposed, based on input data (sound volume data) that is output from the audio sensor. In this case, each of a plurality of sets of learning data used for generating the processing module M1 includes sound volume data and a correct label (correct value) of output data (the number of persons in the room) of the processing module 110 when the sound volume data is input.

Note that the processing module M1 generates one set of output data based on one set of input data, but each of the processing modules 110 does not necessarily need to generate one set of output data based on only one set of input data. The processing module 110 may also generate one set of output data based on a plurality of sets of input data, for example.

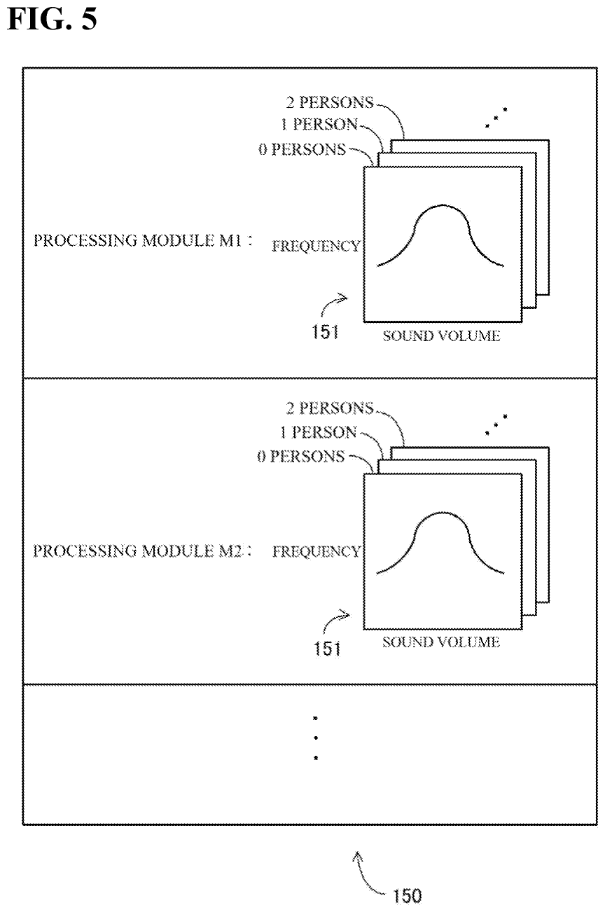

FIG. 5 is a diagram showing an example of the first metadata DB 150. In the example in FIG. 5, first metadata 151 of the processing modules 110 is managed in the first metadata DB 150. The first metadata 151 is generated based on a plurality of sets of learning data used when processing modules 110 with which the first metadata 151 is associated was generated. The first metadata that is associated with the processing modules 110 will be described later in detail, including a generation method and a use method.

Referring to FIG. 3 again, the data buffer 160 is configured to temporarily store sensing data that is output to the processing modules 110 by a sensing device 12. The compatibility of the sensing device 12 that is outputting sensing data to the processing modules 110 is determined based on sensing data that is temporarily stored in the data buffer 160. A compatibility determination method will be described later in detail.

The control program 191 is a control program of the virtual sensor management server 100 that is executed by the control unit 180. The processing modules 110, the first metadata generation module 120, and the compatibility determination module 130 may also be realized as a result of the control unit 180 executing the control program 191, for example. When the control unit 180 executes the control program 191, the control program 191 is deployed to the RAM 184. The control unit 180 then controls constituent elements by causing the CPU 182 to interpret and execute the control program 191 deployed in the RAM 184.

### 1-2-3. Software Configuration of Virtual Sensor Management Server

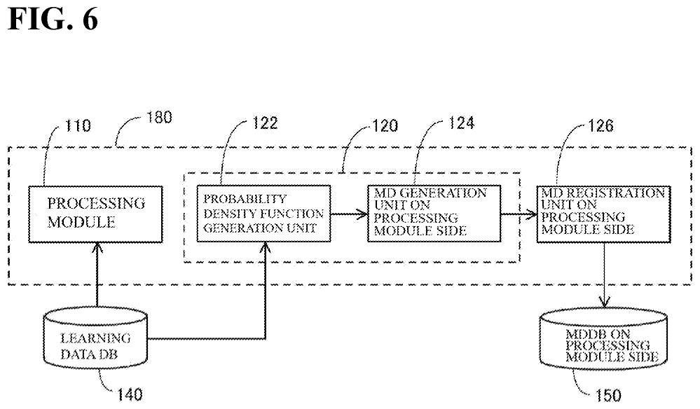

FIG. 6 is a diagram showing an example of a portion of the software configuration of the virtual sensor management server 100 (including the first metadata generation module 120). In the example in FIG. 6, the processing module 110, the first metadata generation module 120, and a first metadata registration unit 126 are realized as a result of the control unit 180 executing the control program 191.

As described above, the processing module 110 is generated by performing training using a plurality of sets of learning data stored in the learning data DB 140.

The first metadata generation module 120 is configured to generate metadata (first metadata) that is associated with the processing module 110, based on learning data used for generating the processing module 110. The first metadata generation module 120 includes the probability density function generation unit 122 and the first metadata generation unit 124.

The probability density function generation unit 122 reads out a plurality of sets of learning data used for generating the processing module 110, from the learning data DB 140. The probability density function generation unit 122 generates a probability density function of a plurality of sets of input data associated with a common correct label. The probability density function generation unit 122 generates a probability density function for each correct label. Accordingly, the probability density function generation unit 122 generates a plurality of probability density functions. Note that, when one set of input data is input to the processing module 110, a resulting probability density function is two-dimensional as indicated by the first metadata 151 in FIG. 5, but, when two or more sets of input data are input to the processing module 110, the number of dimensions in a resulting probability density function increases as the number of sets of input data increases.

The first metadata generation unit 124 generates first metadata (e.g., the first metadata 151 in FIG. 5) based on a plurality of probability density functions generated by the probability density function generation unit 122. The first metadata generation unit 124 regards data of a group of a plurality of probability density functions generated by the probability density function generation unit 122, as first metadata, for example.

The first metadata registration unit 126 associates first metadata generated by the first metadata generation unit 124, with the processing module 110, and registers the first metadata to the first metadata DB 150. In the virtual sensor management server 100 according to the first embodiment, first metadata of the processing module 110 is registered in the first metadata DB 150. The first metadata registered in the first metadata DB 150 is used for various uses.

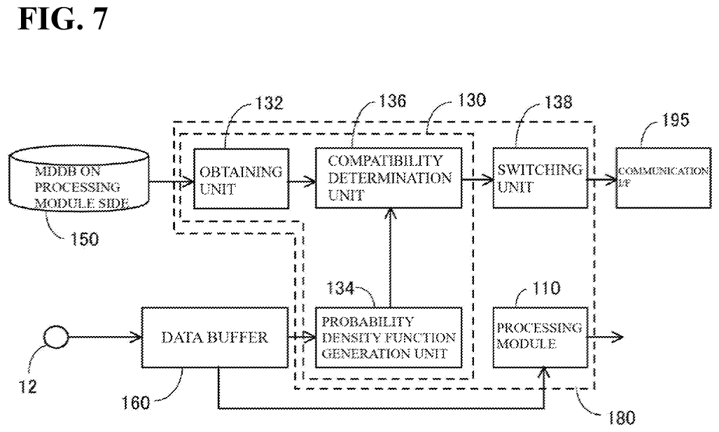

FIG. 7 is a diagram showing an example of a portion of the software configuration of the virtual sensor management server 100 (including the compatibility determination module 130). The configuration shown in the example in FIG. 7 uses first metadata registered in the first metadata DB 150. Note that the compatibility determination module 130, a switching unit 138, and the processing module 110 are realized as a result of the control unit 180 executing the control program 191.

The compatibility determination module 130 determines the compatibility of a sensing device 12 that is outputting input data to the processing module 110, based on first metadata associated with the processing module 110 and input data input to the processing module 110. The compatibility determination module 130 includes an obtaining unit 132, a probability density function generation unit 134, and a compatibility determination unit 136.

The obtaining unit 132 obtains, from the first metadata DB 150, the first metadata associated with the processing modules 110. Note that sensing data output by the sensing device 12 that is to be subjected to compatibility determination has been input to the processing module 110. The sensing data output by the sensing device 12 is temporarily stored in the data buffer 160.

The probability density function generation unit 134 generates a probability density function of a plurality of sets of sensing data temporarily stored in the data buffer 160 (input data). The plurality of sets of sensing data have been generated during a time period during which the environment around the sensing device 12 did not change largely. Accordingly, the probability density function generated by the probability density function generation unit 134 is a probability density function of sensing data that is output by the sensing device 12 (input data that is input to the processing module 110) in a common environment, and indicates the attributes of the sensing device 12 (tendency of output).

The compatibility determination unit 136 determines the compatibility of the sensing device 12 based on the first metadata obtained by the obtaining unit 132 and the probability density function generated by the probability density function generation unit 134. The compatibility determination unit 136 determines, for example, whether or not the similarity between one of a plurality of probability density functions included in the first metadata and the probability density function generated by the probability density function generation unit 134 has at least a predetermined value. Note that one of various known methods may be used for calculating the similarity.

If the similarity has at least the predetermined value, the tendency of output of the sensing device 12 is close to the tendency of output of the sensing device 12 that generated the learning data of the processing module 110, and thus the compatibility determination unit 136 determines that the sensing device 12 is compatible. On the other hand, if the similarity is smaller than the predetermined value, the tendency of output of the sensing device 12 is not close to the tendency of output of the sensing device 12 that generated the learning data of the processing module 110, and thus the compatibility determination unit 136 determines that the sensing device 12 is incompatible.

The switching unit 138 switches the sensing device 12 that outputs sensing data to the processing module 110, based on the result of the determination performed by the compatibility determination unit 136. For example, if the compatibility determination unit 136 determines that the sensing device 12 is incompatible, the switching unit 138 switches the sensing device 12. The switching unit 138 transmits, via the communication I/F 195, an instruction to stop outputting data, to the sensing device 12 that is currently outputting input data to the processing modules 110, and an instruction to start output, to another sensing device 12, for example. On the other hand, for example, if the compatibility determination unit 136 determines that the sensing device 12 is compatible, the switching unit 138 does not switch the sensing device 12.

### 1-3. Operations

### 1-3-1. Metadata Generation Operation

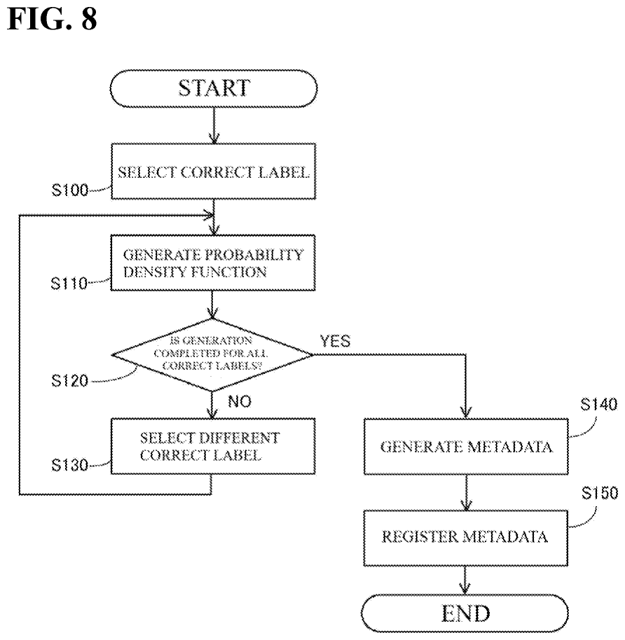

FIG. 8 is a flowchart showing an example of an operation of generating first metadata. The processing indicated in this flowchart is executed after the processing module 110 is generated, by the control unit 180 functioning as the first metadata generation module 120 (FIG. 6), for example.

As shown in FIG. 8, the control unit 180 selects one of a plurality of types of correct labels included in a plurality of sets of learning data used for generating the processing module 110 (step S100). The control unit 180 generates a probability density function based on a plurality of sets of input data (included in the plurality of sets of learning data used for generating the processing modules 110) associated with the selected type of correct label (step S110).

The control unit 180 determines whether or not a probability density function has been generated for all of the types of correct labels included in the plurality of sets of learning data (step S120). If it is determined that no probability density function has been generated for some correct labels (NO in step S120), the control unit 180 selects a correct label of a type different from the type of correct label for which a probability density function has already been generated (step S130). The control unit 180 then repeats the processes of steps S110 to S130, until a probability density function is generated for all of the types of correct labels.

On the other hand, if it is determined in step S120 that a probability density function has been generated for all of the types of correct labels (YES in step S120), the control unit 180 generates first metadata based on all of the generated probability density functions (step S140). The control unit 180 then registers the generated first metadata to the first metadata DB 150 (FIG. 6) (step S150).

As described above, according to the first embodiment, first metadata is generated based on a probability density function of a plurality of sets of input data (included in the learning data) associated with the same correct label. The first metadata reflects the attributes of the sensing device 12 that generated the learning data. By referring to the first metadata, the sensing device 12 whose attributes are similar to the attributes of the sensing device 12 that generated the learning data can be selected as a sensing device 12 that outputs input data to the processing module 110, for example, and it is possible to avoid input of inappropriate data to the processing module 110. Therefore, with the virtual sensor management server 100, it is possible to generate first metadata useful for avoiding input of inappropriate data to the processing module 110.

### 1-3-2. Operation of Determining Compatibility of Sensing Devices

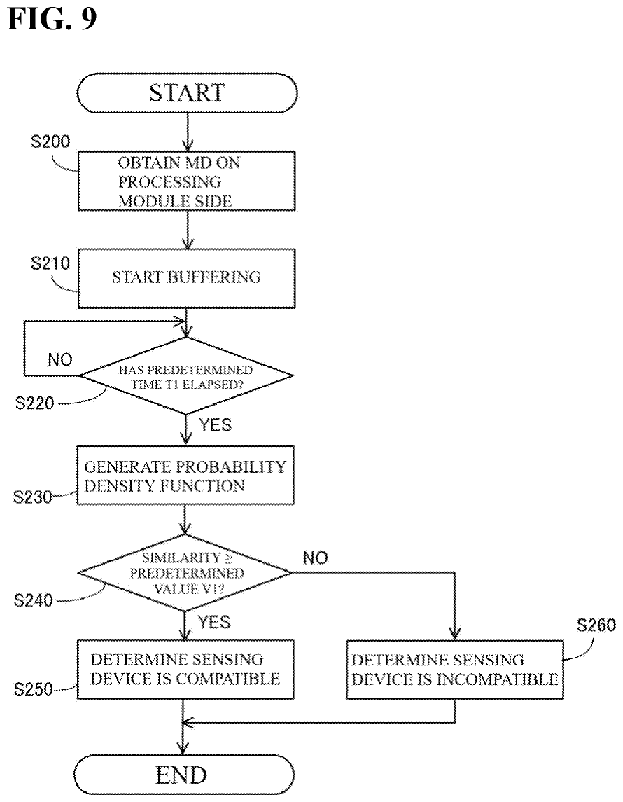

FIG. 9 is a flowchart showing an example of an operation of determining the compatibility of the sensing device 12. The processing indicated in this flowchart is executed at a predetermined interval when sensing data is being output from the sensing device 12 to the processing module 110, for example. Also, the processing indicated in the flowchart is executed as a result of the control unit 180 functioning as the compatibility determination module 130.

As shown in FIG. 9, the control unit 180 obtains first metadata associated with the processing module 110, from the first metadata DB 150 (step S200). Sensing data output by the sensing device 12 that is to be subjected to compatibility determination has been input to the processing module 110 with which first metadata obtained in step S200 is associated.

The control unit 180 lets the data buffer 160 start buffering of the sensing data output to the processing module 110 by the sensing device 12 (step S210). The control unit 180 determines whether or not a predetermined time T1 has elapsed from when buffering started (step S220). If it is determined that the predetermined time T1 has not elapsed (NO in step S220), the control unit 180 continues buffering of the sensing data until the predetermined time T1 elapses. Note that the predetermined time T1 is a time period during which the environment around the sensing device 12 does not change largely, for example.

On the other hand, if it is determined in step S220 that the predetermined time T1 has elapsed (YES in step S220), the control unit 180 generates a probability density function based on a plurality of sets of sensing data stored in the data buffer 160 (step S230). The control unit 180 calculates the similarity between the generated probability density function and each of the plurality of probability density functions included in the first metadata obtained in step S200, and determines whether or not any of the calculated similarities has at least a predetermined value V1 (step S240).

If it is determined that any of the similarities has at least the predetermined value V1 (YES in step S240), the control unit 180 determines that the sensing device 12 is compatible (step S250). On the other hand, if it is determined that all of the similarities are smaller than the predetermined value V1 (NO in step S240), the control unit 180 determines that the sensing device 12 is incompatible (step S260).

As described above, according to the first embodiment, the compatibility of the sensing device 12 that is outputting sensing data to the processing module 110 is determined based on first metadata associated with the processing module 110. That is to say, according to the first embodiment, the attributes (output tendency) of the sensing device 12 that output the learning data used for generating the processing module 110 is sufficiently considered, and the compatibility of the sensing device 12 is then determined. Therefore, with the virtual sensor management server 100 according to the first embodiment, it is possible to more accurately determine the compatibility of the sensing device 12 that outputs input data to the processing modules 110.

In addition, according to the first embodiment, a probability density function generated based on a plurality of sets of sensing data stored in the data buffer 160 is considered when compatibility of the sensing device 12 is determined. Therefore, with the virtual sensor management server 100 according to the first embodiment, it is possible to more accurately determine the compatibility of the sensing device 12 that outputs input data to the processing module 110.

### 1-4. Characteristics

As described above, the metadata generation apparatus according to the first embodiment (the first metadata generation module 120) is configured to generate metadata that is associated with the processing module 110. The first metadata generation module 120 includes the probability density function generation unit 122 and the first metadata generation unit 124. The probability density function generation unit 122 generates probability density functions of a plurality of sets of input data associated with the same correct label (included in the learning data of the processing module 110). The first metadata generation unit 124 generates first metadata based on the generated probability density functions.

The probability density functions generated by the probability density function generation unit 122 reflect the attributes of the sensing device 12 used for generating the learning data. Therefore, first metadata generated based on the probability density functions also reflects the attributes of the sensing device 12 used for generating the learning data. By referring to the first metadata, for example, a sensing device 12 whose attributes are similar to the attributes of the sensing device 12 that output the learning data can be selected as a sensing device 12 that outputs input data to the processing modules 110. As a result, it is possible to avoid a situation where inappropriate data is input to the processing module 110. Therefore, with the metadata generation apparatus 50, it is possible to generate metadata (first metadata) that is useful for avoiding input of inappropriate data to the processing module 110.

Note that the processing module 110 is an example of a “processing module” according to the present invention, first metadata is an example of “metadata” according to the present invention, and the first metadata generation module 120 is an example of a “metadata generation apparatus” according to the present invention. The probability density function generation unit 122 is an example of a “probability density function generation unit” according to the present invention, and the first metadata generation unit 124 is an example of a “metadata generation unit” according to the present invention.

### 2. SECOND EMBODIMENT

According to the above first embodiment, the compatibility of the sensing device 12 that is outputting sensing data to the processing module 110 is determined based on first metadata associated with the processing module 110 and buffered sensing data. Although a detailed description will be given later, according to a second embodiment, metadata on the sensor side (hereinafter, also referred to as “second metadata”) is associated with the sensing device 12 in advance, and the compatibility of the sensing device 12 is determined based on the first metadata and the second metadata. The differences from the first embodiment will be mainly described below.

### 2-1. Configuration

### 2-1-1. Overall System Configuration

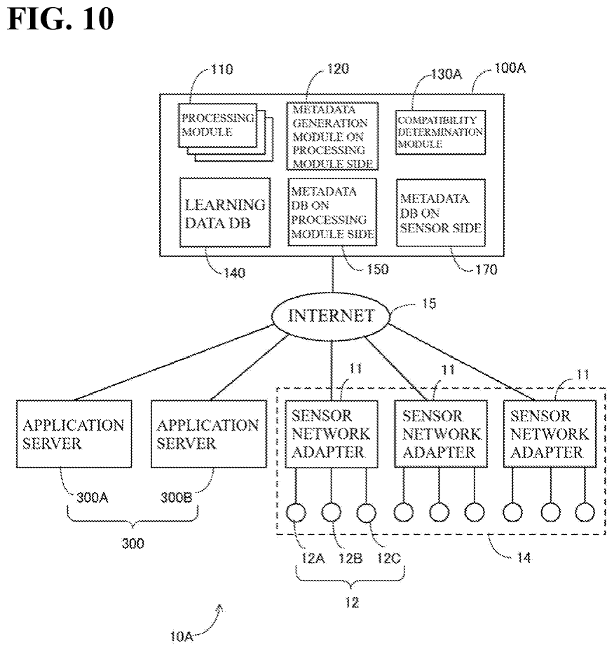

FIG. 10 is a diagram showing a sensor network system 10A according to the second embodiment. In the example in FIG. 2, the sensor network system 10A includes a virtual sensor management server 100A, and the virtual sensor management server 100A includes a metadata DB on the sensor side (hereinafter, also referred to as a “second metadata DB”) 170 and a compatibility determination module 130A. The second metadata DB 170 and the compatibility determination module 130A will be described later in detail.

### 2-1-2. Hardware Configuration of Virtual Sensor Management Server

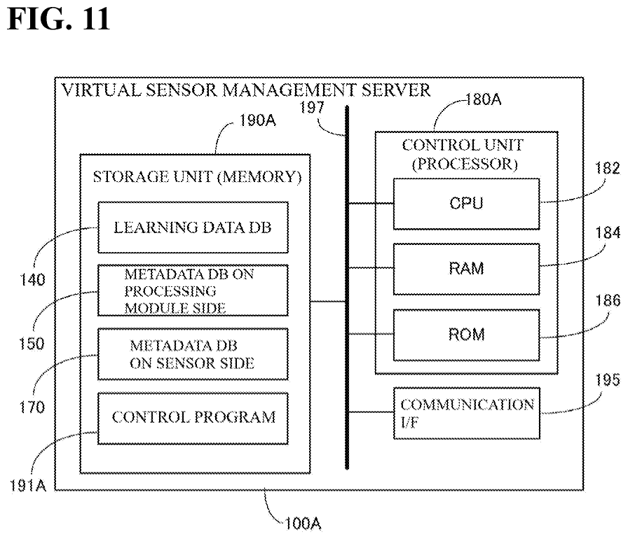

FIG. 11 is a diagram showing the hardware configuration of the virtual sensor management server 100A. In the example in FIG. 11, the virtual sensor management server 100A includes a control unit 180A and a storage unit 190A, and the storage unit 190A stores the second metadata DB 170 and a control program 191A.

The control unit 180A includes the CPU 182, the RAM 184, the ROM 186, and the like, and is configured to control the constituent elements in accordance with information processing. The storage unit 190A is a secondary storage device such as a hard disk drive or a solid state drive.

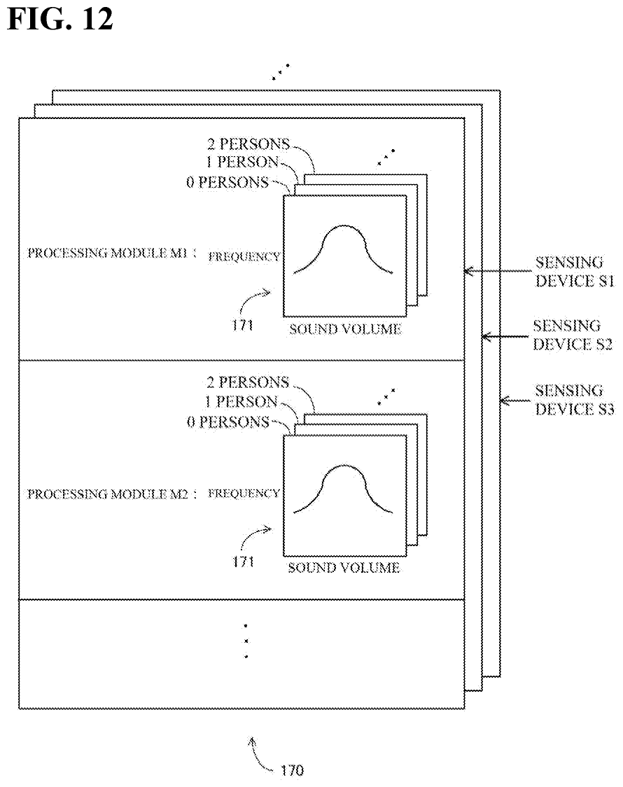

FIG. 12 is a diagram showing an example of the second metadata DB 170. In the example in FIG. 12, in the second metadata DB 170, second metadata 171 is managed for each of the sensing devices 12 included in the sensor network unit 14.

In this example, the second metadata DB 170 manages at least the second metadata 171 associated with sensing devices S1, S2, and S3. Each set of the second metadata is generated based on one of a plurality of sets of input data output to the processing modules 110 by the sensing devices 12 (sensing data). Note that, when each of the plurality of sets of input data is input to the processing modules 110, the processing modules 110 output the same output value.

For example, regarding the sensing device S1, an example of the second metadata 171 includes a probability density function of sensing data (an output value of the sensing device S1 (input sensor)) when the processing module M1 outputs each output value (common output value) and a probability density function of sensing data when a processing module M2 outputs each output value. The second metadata 171 is generated, for example, when a new sensing device 12 is added to the sensor network unit 14, and when a new processing module 110 is generated in the virtual sensor management server 100A.

### 2-1-3. Software Configuration of Virtual Sensor Management Server

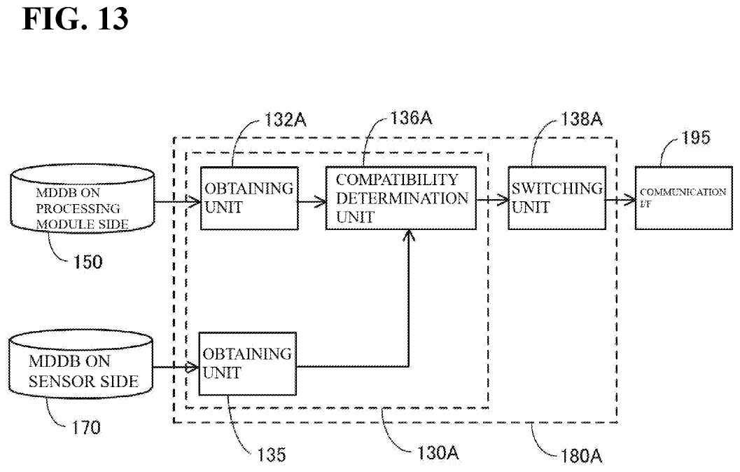

FIG. 13 is a diagram showing an example of a portion of the software configuration of the virtual sensor management server 100A (including the compatibility determination module 130A). The compatibility determination module 130A and a switching unit 138A are realized as a result of the control unit 180A executing the control program 191A.

The compatibility determination module 130A determine the compatibility of a sensing device 12 that is outputting (or scheduled to output) sensing data to a processing module 110, based on first metadata associated with the processing module 110 and second metadata associated with the sensing device 12. The compatibility determination module 130A includes obtaining units 132A and 135 and a compatibility determination unit 136A.

The obtaining unit 132A obtains first metadata associated with the processing module 110, from the first metadata DB 150. Note that a sensing device 12 to be subjected to compatibility determination may be outputting sensing data to that processing module 110, or may also be scheduled to output sensing data to that processing module 110 (not currently outputting data).

The obtaining unit 135 obtains, from the second metadata DB 170 (FIG. 12), second metadata associated with a processing module 110 to which sensing data is being output (including a processing module 110 to which sensing data is scheduled to be output), from among a plurality of sets of second metadata associated with the sensing device 12 to be subjected to compatibility determination.

The compatibility determination unit 136A determines the compatibility of the sensing device 12, based on the first metadata obtained by the obtaining unit 132A and the second metadata obtained by the obtaining unit 135. The compatibility determination unit 136A determines whether or not the similarity between the first metadata and the second metadata has at least a predetermined value, for example. Note that one of various known methods is used for calculating the similarity.

If the similarity has at least the predetermined value, the tendency of output of the sensing device 12 is close to the tendency of output of the sensing device 12 that generated the learning data of the processing module 110, and thus the compatibility determination unit 136A determines that the sensing device 12 is compatible. On the other hand, if the similarity is smaller than the predetermined value, the tendency of output of the sensing device 12 is not close to the tendency of output of the sensing device 12 that generated the learning data of the processing module 110, and thus the compatibility determination unit 136A determines that the sensing device 12 is incompatible.

The switching unit 138A switches the sensing device 12 that outputs sensing data to the processing module 110, based on the result of the determination performed by the compatibility determination unit 136A. If, for example, the compatibility determination unit 136A determines that the sensing device 12 is incompatible, the switching unit 138A switches the sensing device 12.

For example, if it is determined that the sensing device 12 is incompatible when the sensing device 12 is outputting sensing data to the processing module 110, the switching unit 138A transmits, via the communication I/F 195, an instruction to stop outputting sensing data, to that sensing device 12, and an instruction to start outputting sensing data, to another sensing device 12. In this case, the other sensing device 12 does not necessarily need to be a sensing device 12 of the same type as the sensing device 12 to which the instruction to stop outputting sensing data was transmitted. For example, if the sensing device 12 to which an instruction to stop outputting sensing data was transmitted is a surveillance camera, the sensing device 12 to which a switch is made may be a smartphone (with a camera function). In short, it suffices for the sensing devices 12, between which a switch is made, to have similar functions.

Note that, when the sensing device 12 has not output sensing data yet, the switching unit 138A does not particularly make a switch. In this case, if it is determined that the sensing device 12 is incompatible, compatibility of another sensing device 12 is determined, for example.

2-2. Operation of Determining Compatibility of Sensing device

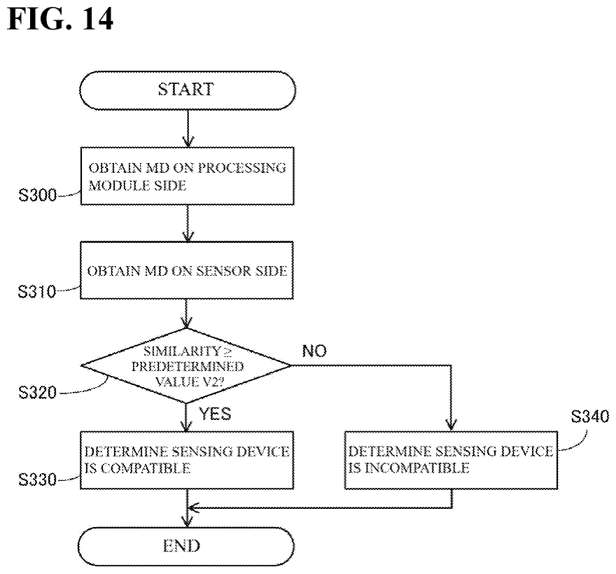

FIG. 14 is a flowchart showing an example of an operation of determining the compatibility of the sensing device 12. The processing indicated in this flowchart is executed at a predetermined interval when sensing data is being output from the sensing device 12 to the processing module 110, for example. Also, the processing indicated in this flowchart is executed, for example, when the sensing device 12 is selected when sensing data is not being input to the processing modules 110. Moreover, the processing indicated in this flowchart is executed as a result of the control unit 180A functioning as the compatibility determination module 130A.

As shown in FIG. 14, the control unit 180A obtains first metadata associated with the processing module 110, from the first metadata DB 150 (step S300). The control unit 180A obtains, from the second metadata DB 170, second metadata associated with a processing module 110 to which sensing data is being output (including a processing module 110 to which sensing data is scheduled to be output), from among a plurality of second metadata associated with a sensing device 12 that is to be subjected to compatibility determination (step S310).

The control unit 180A calculates the similarity between the first metadata obtained in step S300 and the second metadata obtained in step S310, and determines whether or not the calculated similarity has at least a predetermined value V2 (step S320).

If it is determined that the similarity has at least the predetermined value V2 (YES in step S320), the control unit 180A determines that the sensing device 12 is compatible (step S330). On the other hand, if it is determined that the similarity is smaller than the predetermined value V2 (NO in step S320), the control unit 180A determines that the sensing device 12 is incompatible (step S340).

As described above, according to the second embodiment, the compatibility of the sensing device 12 is determined based on first metadata associated with the processing module 110 and second metadata associated with the sensing device 12. Therefore, with the virtual sensor management server 100A according to the second embodiment, the attributes of the sensing device 12 that is outputting input data to the processing module 110 are sufficiently considered by referring to the second metadata, and thus it is possible to more accurately determine the compatibility of the sensing device 12.

### 3. MODIFIED EXAMPLES

The first and second embodiments have been described, but the present invention is not limited to the above first and second embodiments, and various modifications can be made without departing from the spirit thereof. Modified examples will be described below. However, the following modified examples can be combined as appropriate.

3-1

According to the above first and second embodiments, the learning data DB 140 is provided in the virtual sensor management server 100 or 100A. However, the learning data DB 140 does not necessarily need to be provided in the virtual sensor management server 100 or 100A. The learning data DB 140 may also be stored in another server connected to the Internet 15, for example.

3-2

In addition, according to the above first and second embodiments, probability density functions themselves are included in the first metadata. However, probability density functions themselves do not necessarily need to be included in the first metadata. The first metadata may only include, for example, the range of an input value for which a frequency (probability) in a probability density function is smaller than a predetermined value or the range of an input value range for which a frequency (probability) in a probability density function has at least the predetermined value.

3-3

In addition, according to the above second embodiment, probability density functions themselves are included in the second metadata. However, probability density functions themselves do not necessarily need to be included in the second metadata. The second metadata may only include, for example, the range of an input value for which a frequency (probability) in a probability density function is smaller than a predetermined value or the range of an input value range for which a frequency (probability) in a probability density function has at least the predetermined value.

3-4

In addition, according to the above first and second embodiments, sensing data output by the sensing device 12 is input to the processing module 110. However, data input to the processing module 110 is not limited to sensing data output by the sensing device 12. Sensing data (e.g., dataset) accumulated in a database on a server in advance may also be input to the processing module 110, for example. Also, sensing data output by a virtual sensor may also be input to the processing module 110, for example.

3-5

In addition, according to the above first and second embodiments, processing performed by the virtual sensor management server 100 or 100A may also be realized by a plurality of servers, and the like.

### LIST OF REFERENCE NUMERALS

10,10A Sensor network system
11 Sensor network adapter
12 Sensing devices
14 Sensor network unit
15 Internet
50 Metadata generation apparatus
100,100A Virtual sensor management server
110 Processing module
120 Metadata (first metadata) generation module on processing module side
122 Probability density function generation unit
124 Metadata (first metadata) generation unit on processing module side
126 Metadata (first metadata) registration unit on processing module side
130,130A Compatibility determination module
132,132A,135 Obtaining unit
134 Probability density function generation unit
136,136A Compatibility determination unit
138,138A Switching unit
140 Learning data DB
150 Metadata (first metadata) DB on processing module side
151 First metadata
160 Data buffer
170 Metadata (second metadata) DB on sensor side
171 Second metadata
180,180A Control unit
182 CPU
184 RAM
186 ROM
190,190A Storage unit
191,191A Control program
195 Communication I/F
197 Bus
300 Application server

1. A metadata generation apparatus configured to generate metadata that is associated with a processing module,
wherein the processing module is a trained model generated by using a plurality of sets of learning data, and is configured to generate, based on at least one set of input data, output data that is different from the input data,
each of the plurality of sets of learning data comprises input data and a correct label of the output data associated with the input data, and
the metadata generation apparatus comprises:
a probability density function generation unit configured to generate a probability density function of a plurality of sets of input data associated with the same correct label, and
a metadata generation unit configured to generate metadata based on the probability density function.

2. The metadata generation apparatus according to claim 1,
wherein the probability density function generation unit is configured to generate a probability density function for each correct label included in the plurality of sets of learning data.

3. The metadata generation apparatus according to claim 1,
wherein the input data comprises sensing data that is output by a sensing device.

4. The metadata generation apparatus according to claim 1,
wherein the processing module is configured to generate the output data based on the plurality of sets of input data.

5. The metadata generation apparatus according to claim 1,
wherein a virtual sensor is formed of the processing module and a device that outputs the input data to the processing module.

6. A metadata generation method for generating metadata that is associated with processing module,
wherein the processing module is a trained model generated by using a plurality of sets of learning data, and is configured to generate, based on at least one set of input data, output data that is different from the input data,
each of the plurality of sets of learning data comprises input data and a correct label of output data associated with the input data, and
the metadata generation method comprises:
generating a probability density function of a plurality of sets of input data associated with the same correct label, and
generating metadata based on the probability density function.

7. A non-transitory computer-readable storage medium storing a program that causes a computer to execute processing for generating metadata that is associated with a processing module,
wherein the processing module is a trained model generated by using a plurality of sets of learning data, and is configured to generate, based on at least one set of input data, output data that is different from the input data,
each of the plurality of sets of learning data comprises input data and a correct label of output data associated with the input data, and
the program is configured to, which when read and executed, cause the computer to perform operations comprising:
generating a probability density function of a plurality of sets of input data associated with the same correct label, and
generating metadata based on the probability density function.

8. The metadata generation apparatus according to claim 2,
wherein the input data comprises sensing data that is output by a sensing device.

9. The metadata generation apparatus according to claim 2,
wherein the processing module is configured to generate the output data based on the plurality of sets of input data.

10. The metadata generation apparatus according to claim 2,
wherein a virtual sensor is formed of the processing module and a device that outputs the input data to the processing module.

11. The metadata generation apparatus according to claim 3,
wherein the processing module is configured to generate the output data based on the plurality of sets of input data.

12. The metadata generation apparatus according to claim 3,
wherein a virtual sensor is formed of the processing module and a device that outputs the input data to the processing module.

13. The metadata generation apparatus according to claim 4,
wherein a virtual sensor is formed of the processing module and a device that outputs the input data to the processing module.

14. The metadata generation apparatus according to claim 8,
wherein the processing module is configured to generate the output data based on the plurality of sets of input data.

15. The metadata generation apparatus according to claim 8,
wherein a virtual sensor is formed of the processing module and a device that outputs the input data to the processing module.
